(19) United States
(12) Patent Application Publication
(10) Pub. No.: US 2016/0026220 A1
(43) Pub. Date: Jan. 28, 2016

(54) DEFORMABLE DISPLAY DEVICE AND COMPUTER WITH HOUSING

(71) Applicant: Christian Stroetmann, Moers (DE)

(72) Inventor: Christian Stroetmann, Moers (DE)

(21) Appl. No.: 14/806,355

(22) Filed: Jul. 22, 2015

(30) Foreign Application Priority Data
Jul. 23, 2014 (DE) 20-2014-103-404.8

(51) Int. Cl. G06F 1/16; G06F 3/041

(52) U.S. Cl. CPC G06F 1/1652; G06F 3/0412; G06F 3/0416; G06F 2203/04102

(57) ABSTRACT

Embodiments of a deformable electronic visual display device and a deformable mobile computer having such a display device are disclosed. The basic electronic visual display device comprises a deformable display device, at least one control system, and a deformable housing containing the electronic components. In some embodiments, the deformable display device can have an adjustment means for the housing, additional sensors of various types, a wireless communication interface, and a wireless power supply. For independent use some embodiments of the deformable electronic visual display device can also comprise an electronic module including at least one processor and at least one data memory, and also at least one electrical energy storage device being contained in the deformable housing as well. This permits the deformable electronic display device to provide a broad range of functionalities and application possibilities, and to assume novel functionalities and applications.

### CROSS-REFERENCE TO RELATED APPLICATION

This application claims the benefit of the German Utility Model Application No. 20-2014-103-404.8, filed Jul. 23, 2014, and entitiled “Elektronische, visuelle Vorrichtung mit optischer Signalisierung, Steuerungssystem and Gehäuse”, which is hereby incorporated by reference in its entirety.

### BACKGROUND

1. Field of the Disclosure

The present application relates generally to deformable display devices, deformable housings or cases containing said deformable display devices, and stationary and portable computing devices with such a display and housing.

2. Description of the Related Art

People are using various types of devices with display devices having various dimensions, such as a television set, a stationary all-in-one desktop computer system, and a mobile computer system, to view content and to carry out arbitrary tasks for various personal and professional reasons. The typical device is flat and rigid, and the display is either vertically standing, horizontally lying, or being held at an angle. But such devices are not bound to a flat shape and a rigid housing or case. For example, one direction of technological development are deformable devices, which can be flexed, folded, rolled, bent, twisted, stretched, or deformed in other ways.

Some devices have been proposed and researched that provide deformable user interfaces, which allow other ways of interaction with the devices and the content presented on the devices' displays by bending, twisting, stretching, and by other such deforming ways. However, despite all the advantages these user interfaces and related deformable devices have not found their way into everyday applications yet. A reason might be that only non-functional design concepts for marketing activities and functional prototypes for conducting related experiments of such deformable devices have been presented, but no complete marketable product with a device housing made of an elastic polymer or elastomer.

In the research project “Gummi: A User Interface for Deformable Computers”, such a user interface and a related prototypical device for testing the user interface were developed. The functional Gummi prototype consists of conventional, rigid components mounted on a flexible plexiglass base. A thin-film transistor (TFT) color display is attached to the center of the base in such a way, that the base can be easily bent by the user without affecting the viewing position of the display. A trackpad is mounted on the bottom of the base and is used as a 2D position sensor. Two resistive bending sensors are mounted on opposing sides of the flexible base. Each sensor measures bending in one direction, so that the combined measurements of the opposed sensors can be interpreted as two directions of bending.

Display, trackpad, and bending sensors are connected to a stationary computer system running the “Gummi” user interface software application. An analog-to-digital converter with appropriate circuitry is used as an interface between bending sensors and computer. Plastic handles on the sides of the base indicate the intended two-handed grip and make the prototype more comfortable to hold.

But the functional “Gummi” prototype had no deformable housing, case, or enclosure, and the documentation gives no indication that a complete device could have a housing made of for example a rubber, despite that rubber is the English word for the German word gummi.

In the research project “Twend: Twisting and Bending as new Interaction Gesture in Mobile Devices”, a user interface and two related prototypical devices for testing the user interface were developed. One “Twend” prototype has a plastic plate and a layer of a foam and the other prototype is made completely out of a foam. But the documentation gives no information about the material the foam is made of.

Furthermore, in some disclosures electronic devices are described that have a flexible circuit and housing or case.

In U.S. Pat. No. 6,307,751, issued Oct. 23, 2001, and entitled “Flexible circuit assembly”, a device with a flexible circuit is disclosed, which can have a flexible display that may travel over a flexible substrate attached to the flexible display, thereby allowing at least one flexible substrate to be flexed without putting stress on the flexible display. Such a device depends on at least one layer of a flexible substrate with conductive material deposited on. As material for the housing or enclosure containing the flexible circuit or/and the flexible display only some kind of leather is specified in the case of the preferred embodiment in the shape of a wallet.

Several individuals and corporations have also developed or are developing flexible, foldable, rollabble, bendable, twistable, or stretchy devices with visual displays and presented related design concepts. But the documentations of the known design concepts either describe only the display technology, the user interface, and other functionalities of a related device, give no details about the material the housing, case, or enclosure is made of, explain that the housing is not completely made out of an elastic material, or explain that related devices are only foldable.

Despite flexible and deformable electronic components have been presented, especially display devices and circuit assemblies, descriptions of housings, cases, or enclosures inclusive precise specifications of the materials used for their manufacturing of a complete deformable electronic device are missing. Moreover, still not all problems have been solved with such flexible, foldable, rollabble, bendable, twistable, or stretchy electronic devices and accordingly several areas of technical problems and general demands have been determined, which can be solved with other ways of constructing flexible and deformable electronic component assemblies, that do not depend on only flexible circuits but also allow to use rigid integrated circuits as well, and with housings for such devices, which are made of one or more deformable materials, support and protect the contained electronic components against damages, and make device constructions possible that have a more aesthetical appearance.

### SUMMARY

In accordance with the purpose of the invention, as embodied and broadly described, the invention pertains to a deformable electronic visual display device, and extensions of such an electronic device to a deformable stationary computer system and a deformable mobile computer system. The disclosed electronic device comprises a deformable display, at least one control system, and a deformable housing containing the electronic components, and provides different input modalities including touching, folding, bending, stretching, and twisting, as well as further functionalities and application possibilities, which also provide the foundations for novel functionalities and applications.

In order to achieve the above and other objects, several embodiments of the present invention provide different basic types of the deformable display, which can be a light-emitting diode display, a quantum dot based light-emitting diode display, a laser diode display, an electronic paper display, an interferometric modulation display, and an optoelectronic phase-changing film display, and also different functional types, which can be a touch screen and a stretch-sensitive screen, and also a three-dimensional display device, and a multi-layer display device.

Furthermore, several embodiments of the present invention also provide different basic types of the deformable housing and the substrate of the drive electronics layer and the imaging layer of the deformable display, which can be a synthetic rubber, a silicone rubber, a chloroprene rubber respectively polychloroprene, a nitrile rubber, a polyurethane, a polydimethylsiloxane, and a polyimid.

In some embodiments the housing has also an adjustment means for keeping the deformable device in a specific configuration.

Depending on the way of construction and the properties of the used materials for the electronic components and the housing, the disclosed deformable electronic visual display device can be lightweight, slip-resistant, and shockproof, as well as dust tight, splashproof, waterproof and floatable, and even suitable for continuous immersion in water. Furthermore, it can be flexed, folded, rolled, bent, stretched, twisted, and deformed in other ways without damaging its deformable display and other electronic components mounted on or contained within the housing.

Advantageously, a person, that has been hit by or has fallen on such a deformable device, cannot be injured and therefore it is ideally suited for being used by children and within vehicles. In addition, due to its low weight such a device can even fall from a great height without getting damaged, because it approaches the ground in a leaf-like movement with relatively slow velocity. Besides the low weight, easier and safer ways to transport and store a relatively large deformable electronic visual display device are also given by the possibility to fold or roll it together.

In some embodiments, the deformable electronic visual display device can also have a wireless communication interface and a wireless power supply. For independent use some embodiments of the deformable electronic visual display device also comprises an electronic module including at least one processor and at least one data memory, and also at least one electrical energy storage device being contained in the deformable housing as well.

In addition, several embodiments also provide at least one contactless sensor of various types, such as a two-dimensional and a three-dimensional sensor, and different types of related control systems. With these components the deformable electronic visual display device is able to capture various optical, acoustical, and other physical information by the sensors, and to process the captured sensor information, execute predetermined functions, and issue corresponding commands to control other electronic components of the electronic device by the related control systems accordingly. A preferred class of functionality provided in this way comprises various types of user interfaces, such as a natural user interface based on contactless gestures and a voice user interface for example, which all can be combined with each other and with the user interfaces based on other input modalities including touching, folding, bending, stretching, and twisting to realize multimodal user interfaces.

The invention may be implemented in numerous ways. Exemplary preferred embodiments of the present invention is a deformable tablet computer with a three-dimensional camera that is discussed below, but not limited to such a portable electronic device. Depending on its dimension and features the disclosed invention applies to for example a mobile phone or cell phone, specifically a smartphone, an all-in-one desktop computer, a television set, a smart mat, and such alike as well. In this conjunction it has to be understood that all the components or electronic units, which form the various parts of said deformable electronic visual display devices and which are known to those skilled in the art in the field of computer engineering, will not be described in detail. Only said components necessary to the elaboration of preferred embodiments of a deformable electronic visual display device according to the invention will be described.

Other systems, methods, features, advantages, objects, and further areas of applicability together with a more complete understanding of the disclosure will be, or will become, apparent and appreciated to one with skill in the art upon examination of the following figures and detailed description, or may be learned by practice of the present invention. It is intended that all such additional systems, methods, features, and advantages be included within this description, be within the scope of the present disclosure, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed, but are not intended to limit the scope of the disclosure.

### BRIEF DESCRIPTION OF THE DRAWINGS

The accompanying drawings, which are included to provide a further understanding of the disclosure and are incorporated herein and constitute a part of this application, illustrate embodiment(s) of the disclosure and together with the description serve to explain the principle of the disclosure. In the drawings:

FIG. 1 illustrates a perspective view of a deformable electronic visual display device according to a first embodiment in a bent and twisted configuration;

FIG. 2A illustrates a top view of an example portable deformable computing device according to a second embodiment;

FIG. 2B illustrates a top view of an example deformable layer with electronic components of the portable deformable computing device shown in FIG. 2A;

FIG. 2C illustrates a top view of an example deformable layer with electric energy storage devices of the portable deformable computing device shown in FIG. 2A;

FIG. 2D illustrates a sectional view of the example portable deformable computing device along the line A-A shown in FIG. 2A;

FIG. 3A illustrates a top view of an example portable deformable electronic computing device according to a third embodiment;

FIG. 3B illustrates a side view of a portion of the portable deformable electronic computing device shown in FIG. 3A laying out flat;

FIG. 3C illustrates a side view of the portable deformable electronic computing device shown in FIG. 3A being folded;

FIG. 4A illustrates a side view of an example deformable electronic visual display device according to a fourth embodiment in a folded configuration;

FIG. 4B illustrates a side view of the deformable electronic visual display device shown in FIG. 4A in a bent configuration;

FIG. 5A illustrates a side view of a portion of an example portable deformable electronic computing device according to a fourth embodiment laying out flat;

FIG. 5B illustrates a sectional view of the portable deformable electronic computing device along the line B-B′ shown in FIG. 5A.

### DETAILED DESCRIPTION OF THE INVENTION

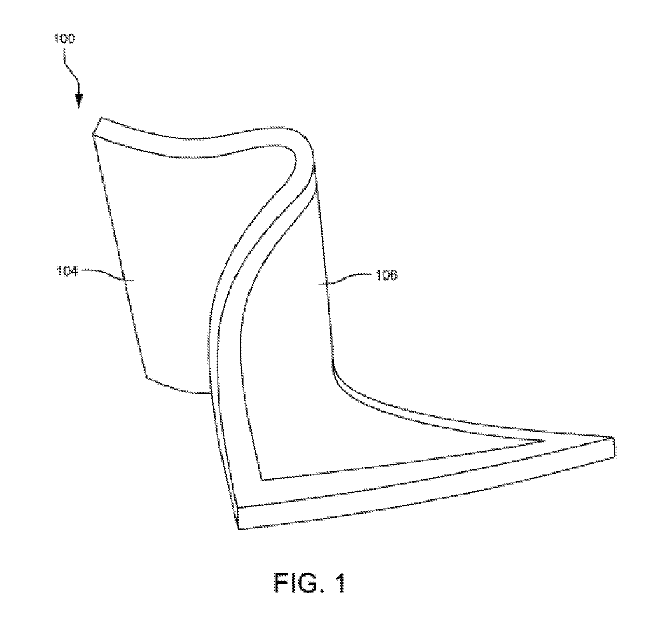

In order to provide various functionality described herein, FIG. 1 illustrates an example of a deformable electronic visual display device according to a first embodiment that can be used to provide functions in accordance with various embodiments discussed and suggested herein. The deformable device comprises a deformable housing 104 and a deformable display 106. FIG. 1 shows in a bent configuration.

As would be apparent to one of ordinary skill in the art, the display device can include different basic types of display layer elements such as a liquid crystal display (LCD), organic light emitting diode (OLED) display, quantum dot based light emitting diode (QLED) display, electronic paper display, interferometric modulator display (IMOD), and an optoelectronic phase-changing film display, and also different functional types, which can be a touch screen and a stretch-sensitive screen, and also a three-dimensional display device, and a multi-layer display device.

Furthermore, the deformable housing and the substrate of the drive electronics layer and the imaging layer of the deformable display can be made of different materials, such as a synthetic rubber, a silicone rubber, a chloroprene rubber respectively polychloroprene, a nitrile rubber, a polyurethane, a polydimethylsiloxane, and a polyimid.

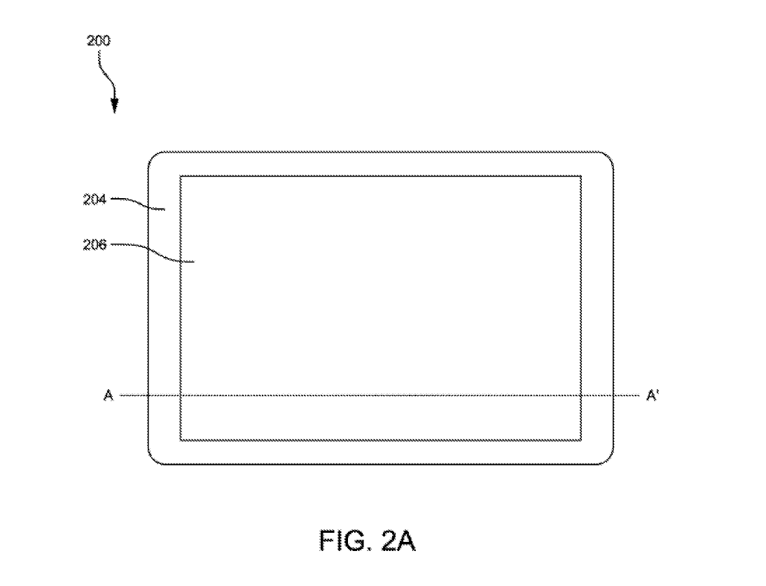

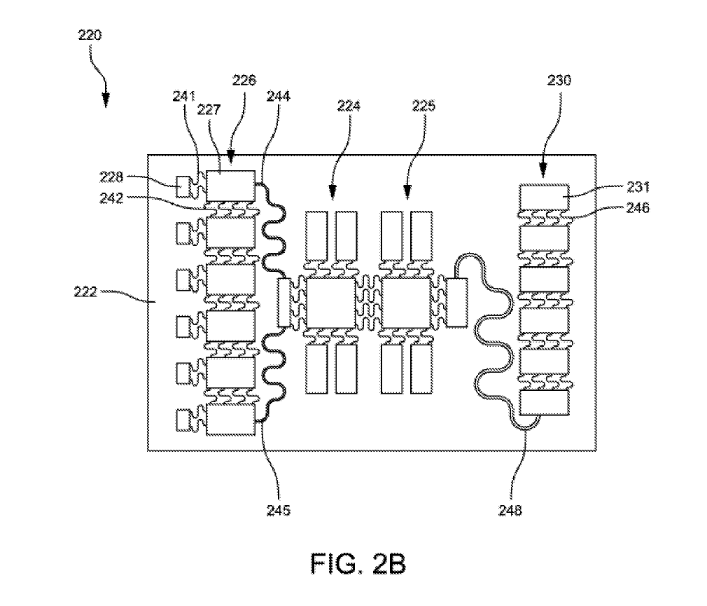

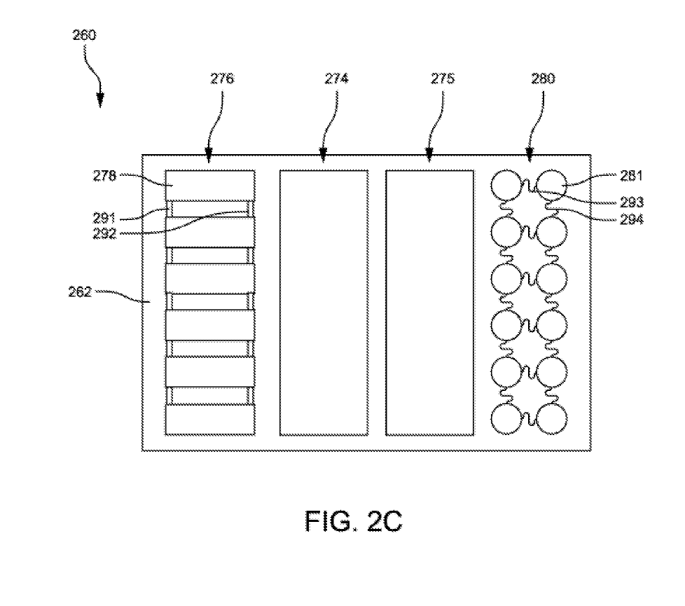

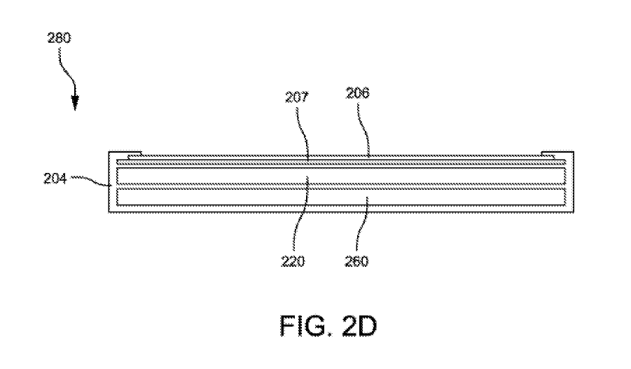

FIGS. 2A, 2B, 2C, and 2D illustrate an example portable computing device with a deformable housing and a deformable electronic visual display according to a second embodiment that can be used to provide functions in accordance with various embodiments discussed and suggested herein. In this example, the portable deformable computing device has a housing 204 and a deformable display 206. The housing contains the layer with electronic components 220 and the layer with electric energy storage devices 240.

FIG. 2A shows the portable deformable computing device with the deformable housing 204 and the deformable display 206, FIG. 2B shows the layer with the electronic components 220 of the portable deformable computing device, FIG. 2C shows the layer with the electric energy storage devices 260 of the portable deformable computing device, and FIG. 2D shows the portable deformable computing device as sectional side view along the line A-A′ in FIG. 2A.

FIG. 2B shows the layer 220 being made of a deformable substrate 222 and having arranged on it an integrated circuit with additional electronic components 224 for processing arbitrary information, a control system 225 for controlling the display and providing other basic functionalities of a computing device, a volatile data storage device 226 comprising several elements, such as a memory component 227 and a related control component 228, and a persistent data storage device 230 comprising several elements, such as a memory component 231, for storing arbitrary data.

Single electronic components are connected by stretchy wires being configured as zigzag springs respectively s-shaped springs. In this example, the memory component 227 is connected with the related control component 228 by the stretchy wire 241 and with the next memory component by the stretchy wire 242. In a similar way the memory component 231 is connected with the next memory component by the stretchy wire 246. The processor module 224 and the control system module 225 are connected with each other by flexible conductive wires, which are not numerated for better illustration. The processor module 224 is connected with the volatile data storage device 226 by the conductive wires 244, 245, and the control system module 225 is connected with the persistent data storage device 230 by the optical wire 248.

FIG. 2C shows the layer 260 being made of a deformable substrate 262 and having arranged on it different types of electric energy storage devices 274, 275, 276, and 280, which are configured to provide the display 206 and the electronic components arranged on the layer 220 shown in FIG. 2B with electric power. The electric energy storage devices 274, 275 are deformable batteries, the electric energy storage device 276 comprises several single battery cells, such as battery cell 278, and the electric energy storage device 280 comprises several single battery cells, such as the button cell or coin cell 281.

The battery cell 278 is connected with the next battery cell by the flexible conductive wires 291,292 and the button cell or coin cell 281 is connected to the next battery cells by the stretchy wires 293, 294.

FIG. 2D shows the arrangement 280 of the layer with the deformable display 206, a deformable support layer 207 for the display, the layer with the electronic components 220, and the layer with the electric energy storage devices 260 within the deformable housing 204.

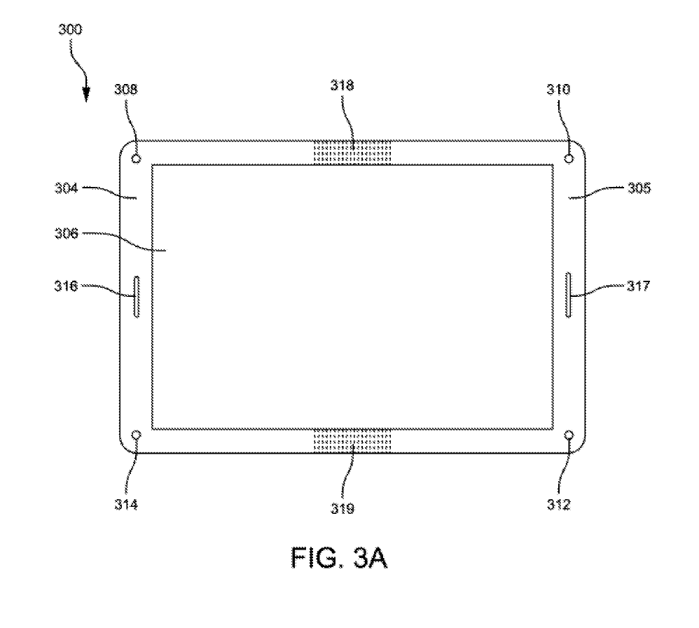

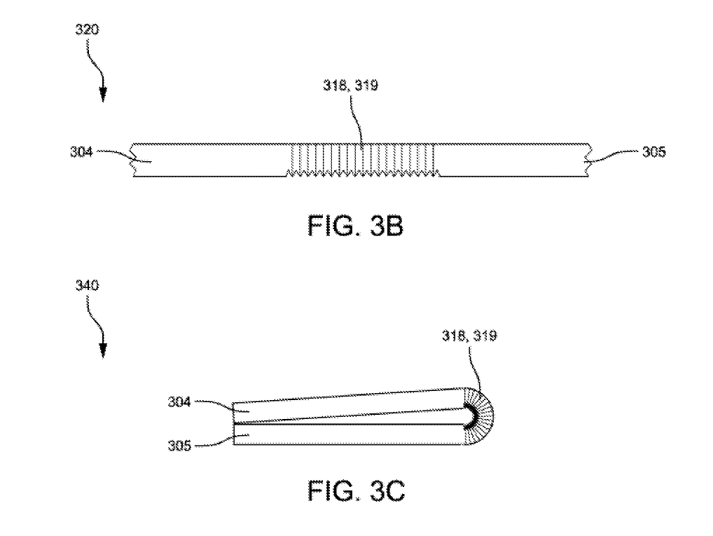

FIGS. 3A, 3B, and 3C illustrate an example portable computing device with a deformable housing and a deformable electronic visual display device according to a third embodiment that can be used to provide functions in accordance with various embodiments discussed and suggested herein. In this example, the portable deformable computing device has a housing comprising two deformable segments 304, 305, bellows-like joint means 318, 319 integrated in the housing and mechanically connecting the segments 304, 305 with each other, a deformable display 306, four information capture elements 308, 310, 312, 314 positioned at various locations on the same side of the portable deformable computing device as the deformable display 306, and integrated dual-array microphones and speakers 316, 317 enabling the portable deformable computing device to capture sensor information about a user of the electronic device during typical operation where the user is at least partially in front of the deformable electronic visual display 306, and to reproduce sound. FIG. 3A shows the portable deformable computing device in the flat laid out configuration 300 from the top,

FIG. 3B shows a portion of the portable deformable computing device in the flat laid out configuration 320 from the side, and FIG. 3C shows the portable deformable computing device in the folded configuration 340 from the side.

In this example, each capture element 308, 310, 312, 314 is a camera capable of capturing image information over a visible or/and infrared (IR) spectrum, and in at least some embodiments can select between visible and IR operational modes. It should be understood, however, that there can be fewer or additional elements of similar or alternative types in other embodiments, and that there can be combinations of cameras, infrared detectors, sensors, and other such elements used with various devices. The device can also have a material and/or components that enable a user to provide input to the device by applying pressure at one or more locations. The device housing segments 304, 305 can also include touch-sensitive material that enables a user to provide input by sliding a finger or other object along a portion of the housing. Various other elements and combinations of elements can be used as well within the scope of the various embodiments as should be apparent in light of the teachings and suggestions contained herein.

Not shown for better illustration are an electronic module comprising at least one integrated circuitry for processing arbitrary information and a data memory for storing arbitrary data, a wireless communication interface device connected with the electronic module, and an electric energy storage device for providing the portable deformable computing device with electric power.

In modifications of the example portable computing device with a deformable housing and a deformable electronic visual display device according to the third embodiment the housing can have an adjustment means to keep the joint means 318, 319 or the whole deformable housing in a specific configuration as preconfigured or chosen by a user. Such an adjustment means can be constructed in various ways by a person ordinarily skilled in the art and therefore is not discussed further herein.

In addition, the example display device can also include at least one motion component, such as an electronic gyroscope, kinds of inertial sensors, or an inertial measurement unit, connected to an information processing circuit of a control system to determine motion of the display device arranged in a portable variant discussed elsewhere herein for assistance in location and movement information or/and user input determination.

Moreover, it is to be understood that any person skilled in the art should be able to construct a deformable electronic visual display device that provides a multi-modal user interface to the user by combining and integrating the various information capture elements and related control systems and control methods. In the same respect, it should be possible without any problems to integrate a wireless electric power link device within the horizontal surface, which is configured to wirelessly receive electric power from an external power supply, and a wireless charging means, which is configured to supply other electrically operated devices layed on the horizontal surface with electric power.

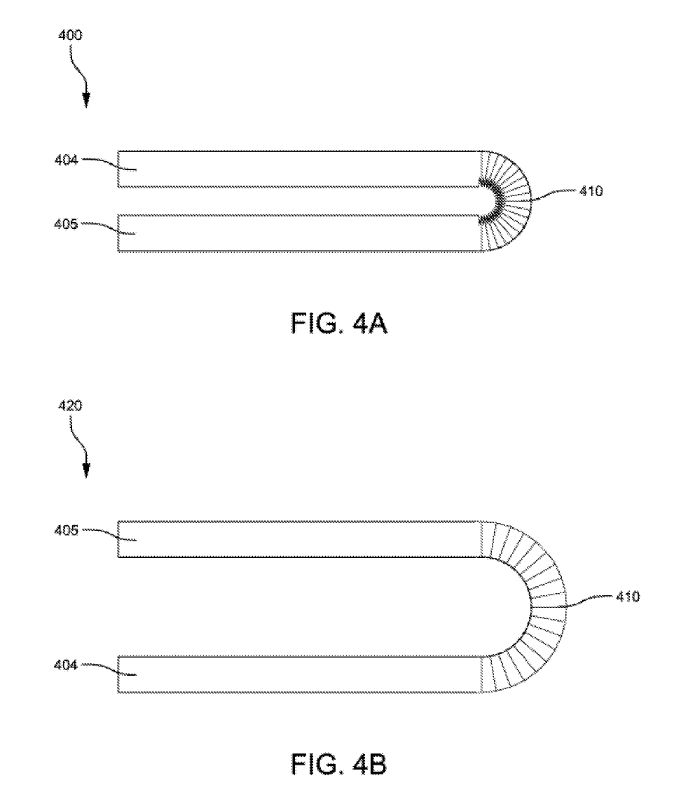

In order to provide various functionality described herein, FIGS. 4A and 4B illustrate an example of a deformable electronic visual display device according to a fourth embodiment similar to the third embodiment shown in FIGS. 3A, 3B, and 3C. The deformable housing of the electronic visual display device comprises a first deformable housing segment 404 and a second deformable housing segment 405, which are connected by a foldabel joint means 410. FIG. 4A shows the joint means of the housing respectively the electronic visual display device in a folded configuration and FIG. 4B shows the joint means of the housing respectively the electronic visual display device in a bent configuration.

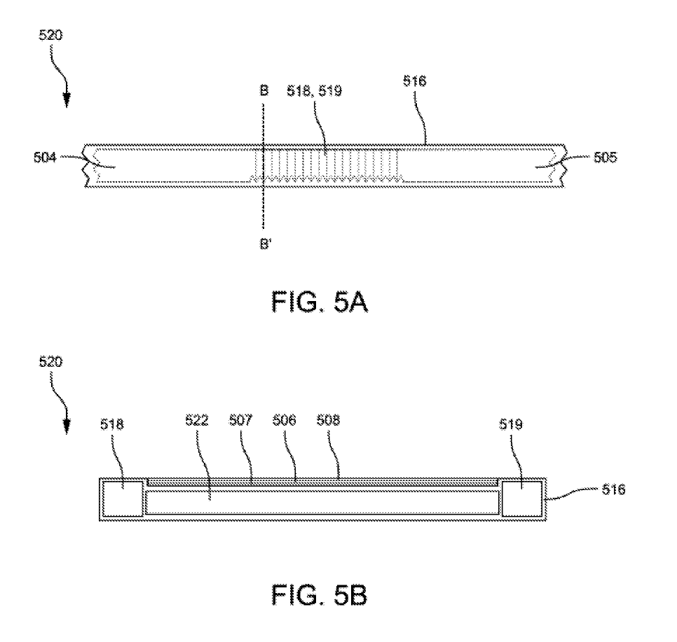

FIGS. 5A and 5B illustrate a portion of an example portable computing device with a deformable housing and a deformable electronic visual display device, such as the device shown in FIG. 3A for example, according to a fifth embodiment of the deformable electronic visual display device that can be used to provide functions in accordance with various embodiments discussed and suggested herein. In this example, the portable deformable computing device has a housing containing two segments 504, 505, bellows-like joint means 518, 519 mechanically connecting the segments 504, 505 with each other, a deformable display 506 with a protection layer 508 and a support layer 507 made of a deformable material, and a deformable shell 516 covering the electronic components of the portable computing device and providing protection against dust and moisture, as well as mechanical impacts.

FIG. 5A shows a portion of a portable deformable computing device similar to the deformable device shown in FIGS. 3A, 3B, and 3C in the flat laid out configuration 520 as side view and FIG. 5B shows a sectional view of the portion of the portable deformable computing device along the line B-B′ shown in FIG. 5A. In this sectional view the layer 522 arranged within the deformable housing can be seen, which is configured to contain the electronic components of a portable computing device, such as the components shown in FIGS. 2A, 2B, and 2C for example, which can comprise solid and deformable hardware components.

The specification and drawings are to be regarded in an illustrative rather than a restrictive sense. It will, however, be evident that various modifications and changes may be made thereunto by those skilled in the art without departing from the broader spirit and scope of the invention as set forth in the claims. In other words, although embodiments have been described with reference to a number of illustrative embodiments thereof, this disclosure is not limited to those. Accordingly, in various embodiments of the invention the various embodiments of the joint means, deformable device housing, and portable computing device discussed and suggested in FIGS. 1, 2A, 2B, 2C, 2D, 3A, 3B, 3C, 4A, 4B, 5A, and 5B can be combined with each other in appropriate ways. The scope of the present disclosure shall be determined only by the appended claims and their equivalents. In addition, variations and modifications in the component parts, arrangements, or/and alternative uses must be regarded as included in the appended claims.

1. An electronic visual display device, comprising:
a deformable display device;
at least one integrated circuit based control system for controlling the display device and for performing other predetermined functions of the display; and
a deformable housing consisting of an elastomer, and containing said deformable display device and said at least one integrated circuit,
wherein the electronic visual display device is deformable in at least one way of (a) bending, (b) twisting, or (c) stretching.

2. The electronic visual display device of claim 1,
wherein the elastomer includes one of (a) a synthetic rubber, (b) a silicone rubber, (c) a chloroprene rubber respectively polychloroprene, (d) a nitrile rubber, (e) a polyurethane, (f) a polydimethylsiloxane, or (g) a polyimid.

3. The electronic visual display device of claim 1,
wherein the deformable housing further comprises:
at least two housing segments; and
at least one joint means,
wherein said at least one joint means is mechanically connecting two adjacent housing segments.

4. The electronic visual display device of claim 3,
wherein the deformable housing further comprises:
at least one spring for keeping at least one joint means of the deformable housing in at least one configuration.

5. The electronic visual display device of claim 1, further comprising:
at least one adjustment means for keeping the deformable housing in at least one configuration.

6. The electronic visual display device of claim 1,
wherein the deformable housing further comprises:
at least one shape-memorizing element being configured to memorize the curvature of the deformable housing for keeping it in its last configuration.

7. The electronic visual display device of claim 1, further comprising:
at least one electric actuator for changing the configuration of the deformable housing.

8. The electronic visual display device of claim 1, further comprising:
at least one stretchy wire being configured as a zigzag spring respectively s-shaped spring and connecting at least two electronic components of the device.

9. The electronic visual display device of claim 1,
wherein the deformable display device includes at least one of (a) an active display, such as (b) liquid crystal display, (c) a light-emitting diode display, (d) a quantum dot based light-emitting diode display, and (e) a laser diode display, or (f) a passive or reflective display, such as (g) an electronic paper display, (h) an interferometric modulation display, and (i) an optoelectronic phase-changing film display.

10. The electronic visual display device of claim 1,
wherein the substrate of the drive electronics layer and the imaging layer of the deformable display device includes one of (a) a synthetic rubber, (b) a silicone rubber, (c) a chloroprene rubber respectively polychloroprene, (d) a nitrile rubber, (e) a polyurethane, (f) a polydimethylsiloxane, or (g) a polyimid.

11. The electronic visual display device of claim 1,
wherein the deformable display device is a touch screen.

12. The electronic visual display device of claim 1,
wherein the integrated circuit based control system is a deformable electronic circuitry.

13. The electronic visual display device of claim 1, further comprising:
an electronic module including:
at least one processor for processing arbitrary informations,
at least one data memory for storing arbitrary data, and
at least one additional integrated circuit based control circuitry being configured for performing predetermined functions of the electronic module,
wherein said electronic module is connected to at least one integrated circuit based control system of the electronic visual display device.

14. The electronic visual display device of claim 13,
wherein the electronic module is a deformable electronic circuitry.

15. The electronic visual display device of claim 13, further comprising:
a wireless communication interface device being configured to transmit and receive electromagnetic radiation, and to connect with other electrically operated devices,
wherein said wireless communication interface device is connected to the electronic module.

16. The electronic visual display device of claim 1, further comprising:
at least one contactless sensor.

17. The electronic visual display device of claim 16,
wherein at least one contactless sensor includes one of (a) and optical two-dimensional sensor, (b) an optical three-dimensional sensor, (c) an acoustical two-dimensional sensor, (d) an acoustical three-dimensional sensor, or (e) a position detecting and motion tracking sensor being configured to track the movement of the electronic visual display device.

18. The electronic visual display device of claim 1,
wherein the deformable housing further comprises:
at least one touch-sensitive sensor.

19. The electronic visual display device of claim 1, further comprising:
a wireless power supply on the basis of induction.

20. The electronic visual display device of claim 1, further comprising:
at least one rechargeable electrical energy storage device being configured to provide electric power to the electronic components of the device,
wherein said at least one energy storage device is arranged within the deformable housing.

21. The electronic visual display device of claim 20,
wherein at least one rechargeable electrical energy storage device is a deformable battery.

22. The electronic visual display device of claim 21,
wherein the substrate of at least one deformable battery includes one of (a) a synthetic rubber, (b) a silicone rubber, (c) a chloroprene rubber respectively polychloroprene, (d) a nitrile rubber, (e) a polyurethane, (f) a polydimethylsiloxane, or (g) a polyimid.
